(19) United States
(12) Patent Application Publication
(10) Pub. No.: US 2025/0257589 A1
(43) Pub. Date: Aug. 14, 2025

(54) EXIT DEVICE PRIVACY FUNCTION

(71) Applicant: Sargent Manufacturing Company, New Haven, CT (US)

(72) Inventors: Darren C. Eller, Madison, CT (US); Andrew S. Geraci, Middlefield, CT (US); Jason Lynch, Orange, CT (US); Ryan Piantek, Higganum, CT (US); Richard D. Sangster, JR., Madison, CT (US)

(73) Assignee: Sargent Manufacturing Company, New Haven, CT (US)

(21) Appl. No.: 19/046,991

(22) Filed: Feb. 6, 2025

Related U.S. Application Data
(60) Provisional application No. 63/551,285, filed on Feb. 8, 2024.

(51) Int. Cl. E05B 65/10

(52) U.S. Cl. CPC E05B 65/1093; E05B 65/1053

(57) ABSTRACT

Privacy locks and status indicators for exit devices are disclosed. An exit device includes a privacy lock configured to transition between a non-privacy configuration and a privacy configuration. The exit device may also include a latch movable between an extended latch position and a retracted latch position. The privacy lock is configured to maintain the latch in extended latch position while in the privacy configuration. The exit device can include an indicator configured to provide an indication associated with the exit device. The indication may indicate that the exit device is locked or unlocked such as in a privacy state or a non-privacy state.

### RELATED APPLICATIONS

This application claims priority under 35 U.S.C. § 119 (e) to U.S. Provisional Application No. 63/551,285, filed Feb. 8, 2024, the content of which is incorporated by reference in its entirety for all purposes.

### FIELD

Disclosed embodiments are related to privacy functions for exit devices.

### BACKGROUND

Exit devices often include one or more actuators such as push bars and door handles which a user may actuate to open a door. In some cases, operation of one or more actuators of the exit device may need to be disabled. An indication can be provided by the exit device to indicate the state of the exit device.

### SUMMARY

In some embodiments, an exit device comprises: a latch configured to move between an extended latch position and a retracted latch position; and a privacy lock configured to transition between a non-privacy configuration and a privacy configuration, wherein in the privacy configuration the privacy lock is configured to maintain the latch in the extended latch position.

In some embodiments, an exit device comprises: a latch movable between an extended latch position and a retracted latch position, a shaft configured to move linearly between a first shaft linear position and a second shaft linear position and rotate between a first shaft rotational position and a second shaft rotational position, wherein the shaft is configured such that rotation of the shaft from the first shaft rotational position to the second shaft rotational position while the shaft is in the first shaft linear position moves the latch from the extended position to the retracted position; a privacy actuator movably coupled to the shaft and configured to move between a non-privacy position and a privacy position, wherein movement of the privacy actuator from the non-privacy position to the privacy position moves the shaft from the first shaft linear position and the second shaft linear position; and a catch configured to selectively maintain the shaft in the second shaft linear position.

In some embodiments, an exit device comprises: a latch configured to move between an extended latch position and a retracted latch position; a privacy actuator configured to transition from a non-privacy configuration to a privacy configuration; a shaft operatively coupled to the privacy actuator and configured to move between a first shaft position and a second shaft position, wherein the shaft is configured to move from the first shaft position to the second shaft position in response to the privacy actuator transitioning from the non-privacy configuration to the privacy configuration, and wherein the shaft is configured to maintain the latch in the extended latch position while in the second shaft position; and an indicator configured to provide an indication associated with the exit device.

In some embodiments, an exit device comprises: a latch configured to move between an extended latch position and a retracted latch position; a latch actuator configured to move between an unactuated position and an actuated position; a coupling configured to move between a coupled position and a decoupled position, wherein in the coupled position the coupling is configured to operatively couple the latch actuator and the latch such that movement of the latch actuator from the unactuated position to the actuated position moves the latch from the extended position to the retracted position; and a button configured to move between a first button position and a second button position, wherein movement of the button from the first button position to the second button position moves the coupling to the decoupled position.

In some embodiments, an exit device comprises a privacy lock configured to transition between a non-privacy configuration and a privacy configuration, wherein in the privacy configuration the privacy lock is configured to maintain the exit device in a locked configuration.

In some embodiments, an exit device comprises: a latch movable between an extended latch position and a retracted latch position; a block movable between a first block position and a second block position, wherein movement of the block from the first block position to the second block position moves the latch from the extended latch position to the retracted latch position; a slide movable between a first slide position and a second slide position; a stop lever movable between a coupled position and a decoupled position, wherein the stop lever is configured to couple movement of the block with the slide while the stop lever is in the coupled position, and wherein, in the decoupled position, the block is decoupled from movement with the slide; and a privacy lock configured to transition between a non-privacy configuration and a privacy configuration, wherein the privacy lock is configured such that transitioning the privacy lock from the non-privacy configuration to the privacy configuration moves the stop lever to the decoupled position.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1A shows a schematic view of an exit device configured to be coupled to a door including multiple rods according to some embodiments;

FIG. 1B shows a schematic view of an exit device configured to be coupled to a door including one rod according to some embodiments;

FIG. 2 shows a schematic view of an exit device configured to be coupled to a door including a latch assembly according to some embodiments;

FIG. 3 shows a top view of an exit device including an indicator and an actuator according to some embodiments;

FIG. 4 shows a bottom view of an exit device according to some embodiments;

FIG. 5A shows a perspective view of an exit device including an actuator according to some embodiments;

FIG. 5B shows another perspective view of an exit device including an actuator according to some embodiments;

FIG. 6A shows yet another perspective view of an exit device including an actuator according to some embodiments;

FIG. 6B shows a further perspective view of an exit device including an actuator according to some embodiments;

FIG. 7A shows a perspective view of a privacy lock actuator assembly according to some embodiments;

FIG. 7B shows another perspective view of the privacy lock actuator assembly according to some embodiments;

FIG. 8A shows a perspective view of a catch according to some embodiments;

FIG. 8B shows another perspective view of a catch according to some embodiments;

FIG. 9 shows a perspective view of an exit device including an indicator plate and an indicator face according to some embodiments;

FIG. 10 shows a top view of a status indicator face according to some embodiments;

FIG. 11 shows a perspective view of an exit device including a chassis according to some embodiments;

FIG. 12 shows a perspective view of an exit device including an indicator support structure according to some embodiments;

FIG. 13 shows a perspective view of an exit device including a status indicator face according to some embodiments;

FIG. 14 shows a perspective view of an exit device including a controller and a light source according to some embodiments;

FIG. 15 shows a perspective view of an exit device including a handle and a privacy lock according to some embodiments;

FIG. 16 shows yet another perspective view of a privacy lock actuator assembly according to some embodiments;

FIG. 17 shows an exploded view of the privacy lock actuator assembly of FIG. 16 according to some embodiments;

FIG. 18 shows a perspective view of a sliding assembly according to some embodiments;

FIG. 19 shows an exploded view of the sliding assembly of FIG. 18 according to some embodiments;

FIG. 20 shows a cross-sectional view of the exit device of FIG. 15 according to some embodiments;

FIG. 21A shows a close-up cross-sectional view of an exit device with a privacy lock in a non-privacy configuration according to some embodiments;

FIG. 21B shows a close-up cross-sectional view of the exit device of FIG. 21A with the privacy lock in a privacy configuration according to some embodiments;

FIG. 22A shows a cross-sectional view of an exit device with a privacy lock transitioning from a non-privacy configuration to a privacy configuration and a slide in a first slide position according to some embodiments;

FIG. 22B shows a cross-sectional view of the exit device of FIG. 22A with the privacy lock in the privacy configuration and the slide in the first slide position according to some embodiments;

FIG. 22C shows a cross-sectional view of the exit device of FIGS. 22A-22B with the privacy lock in the privacy configuration and the slide in a second slide position according to some embodiments;

FIG. 22D shows a cross sectional view of the exit device of FIGS. 22A-22C with the privacy lock transitioning to the non-privacy configuration according to some embodiments; and

FIG. 22E shows a cross-sectional view of the exit device of FIGS. 22A-22D with the privacy lock in the non-privacy configuration and the slide in the first slide position according to some embodiments.

### DETAILED DESCRIPTION

An exit device may include a privacy lock. Exit devices often include actuators that may be actuated to change the state of the exit device, for example to unlock and open a door. The actuators may be disabled to prevent the exit device from becoming unlocked, thereby preventing the door from being opened. The privacy lock may be operable to selectively enable and disable operation of the actuators. Exit devices used to secure doors used for spaces within a building or other structure often include an actuator on both sides of the door to enable operation of the associated exit device from an interior and exterior of the space.

The Inventors have recognized a privacy lock that may selectively disable an actuator to disable operation of the exit device may be beneficial in certain environments where shelter or privacy are desired. Examples of such environments include classrooms, bathrooms, meeting rooms, and any other suitable room or space where privacy or shelter are desired. This may be useful in instances where privacy or shelter within the interior of a room is desired. In such instances, an actuator on an exterior side of the door is disabled, thereby preventing operation of the exit device on the exterior side while allowing operation of the exit device using an interior actuator disposed on an interior side of the door. This may serve to prevent intruders or other persons intended from entering the interior of the room. More broadly, a first actuator configured to operate the exit device on a first side of the door may be disabled to prevent operation of the exit device on the first side. The exit device may still be operated from a second side of the door using a second actuator disposed on the second side of the door while the first actuator is disabled. In this regard, the first actuator can be a handle, lever, or knob whereas the second actuator can be a push bar. It should be appreciated that although the term “privacy” is used herein, the term is meant to include other use cases, such as sheltering in place as noted above.

The Inventors have further recognized benefits associated with providing an indication indicative of a state of an exit device, such as whether the exit device is in a privacy state or a non-privacy state. Such an indication may indicate to a user whether or not the exit device may be used to unlock an associated door. For example, if a user receives an indication that the exit device is in a privacy state, the user may decide whether the exit device should be transitioned to a non-privacy state and/or whether to operate the exit device. This may be especially useful in cases where the operation of the exit device transitions the exit device from a privacy state to a non-privacy state. In such cases, undesired transitioning of the exit device to the non-privacy state may be avoided. In another example, if the user receives an indication that the exit device is in the non-privacy state, the user may decide whether to transition the exit device to the privacy state and/or whether to operate the exit device.

The systems and methods described herein may be used in conjunction with a door system. The door system can include a door, a frame, and securement mechanisms such as latch assemblies and/or vertical rods. In some cases, the exit devices described herein may be coupled to a door and configured to selectively secure the door. Selectively securing the door may selectively allow and prevent access to a room associated with the door.

An exit device may include a latch configured to selectively secure the exit device and any associated door. The latch may move between an extended latch position and a retracted latch position, where the latch may secure the exit device and any associated door when in the extended latch position. The exit device may include a privacy actuator, such as a button, configured to transition from an un-actuated configuration to an actuated configuration. Transitioning the privacy actuator from the un-actuated configuration to the actuated configuration may maintain the latch in the extended latch position. In some embodiments, the privacy actuator is operatively coupled to the latch, optionally via one or more components. For example, the exit device may include a shaft configured to move between a first shaft position and a second shaft position and operatively coupled to the privacy actuator and the latch. The shaft is configured to maintain the latch in the extended latch position while in the second shaft position according to some embodiments.

The exit device may include a catch configured to selectively maintain the shaft in the second shaft position. For example, the catch may be configured to engage the shaft when the shaft is moved to the second shaft position to maintain the shaft in the second shaft position. The shaft may be configured to disengage the shaft to allow the shaft to move from the second shaft position to the first shaft position. In some embodiments, an actuator of the exit device, such as a push bar, is actuated to disengage the catch from the shaft, thereby enabling movement of the shaft from the second shaft position to the first shaft position.

In some embodiments of the exit device having a privacy lock, the exit device includes a block movable between a first block position and a second block position, where moving the block to the second block position moves the latch from the extended latch position to the retracted latch position. The exit device may include a slide movable between a first slide position and a second slide position and which may be selectively coupled in movement with the block. For example, the exit device may include a stop lever which is configured to selectively couple movement of the block with the slide and is movable between a coupled position and an uncoupled position. In the coupled position, the stop lever may couple the movement of the slide and the block such that movement of the slide from the first slide position to the second slide position may move the block from the first block position to the second block position. Accordingly, while the stop lever is in the coupled position, moving the slide may move the block to retract the latch of the exit device. In the decoupled position, the stop lever may be configured such that movement of the slide does not cause movement of the block. In other words, the movement of the block is decoupled from movement with the slide while the stop lever is in the decoupled position.

The privacy lock, in some embodiments, is operable to move the stop lever from the coupled position to the uncoupled position. For example, movement of the privacy actuator from an unactuated position to an actuated position, e.g., movement of a button from a first button position to a second button position, may move the stop lever from the coupled position to the decoupled position. In some embodiments, a projection of the button may be configured to move the stop lever from the coupled position to the decoupled position. For example, moving the button from the first button position to the second button position may move the projection of the button thereby moving the stop lever to the decoupled position. In some cases, the stop lever may optionally be positioned at least partially or entirely within an interior space of the block. In such cases, the projection of the button may be configured to extend at least partially inside of the interior space of the block, e.g., through a block access port of the block, to move the stop lever. The stop lever may be configured to contact a coupling surface of the block in the coupled position and may be configured to be free of contact with the coupling surface in the decoupled position according to some embodiments. In some cases, the slide may be coupled in movement with the block via the stop lever contacting the coupling surface. In some embodiments, the stop lever is movably coupled to the slide. For example, the stop lever may be rotatably coupled to the slide and may be configured to rotate between the coupled position and the decoupled position. The stop lever may be biased to the coupled position according to some embodiments, e.g., with a biasing element such as a spring.

In some cases, the slide may be movably coupled to actuator of the exit device, such as a knob. The knob may be movable coupled to the slide, e.g., rotation of the knob may move the slide between the first slide position and the second slide position.

The exit device may include a trim lever operatively coupled to a latch actuator of the exit device, such as a door handle, and configured to move the latch from the extended latch position to the retracted latch position. The door handle is operatively coupled to the trim lever via the shaft according to some embodiments. In such embodiments, the shaft is movably coupled to the door handle and is configured to rotate to move the trim lever. For example, the shaft may be configured to rotate between a first shaft rotational position and a second shaft rotational position. As previously described above, the shaft may be movable between the first shaft position and the second shaft position. In some embodiments, the shaft is configured to move linearly between a first shaft linear position and a second shaft linear position. The shaft may be configured to engage the trim lever while in the first shaft linear position, thereby operatively coupling the door handle to the trim lever and the latch. The shaft may be configured to decouple the door handle from the trim lever and the latch while in the second shaft linear position. In some cases, the door handle is operated while the shaft is in the second shaft linear position, and the shaft may rotate in response to operation (e.g., rotation) of the door handle, and the trim lever and latch may maintain their respective positions. In other cases, the door handle may be disabled, for example by preventing rotation of the door handle, while the shaft is in the second shaft linear position or otherwise while the privacy lock is in the privacy configuration. Any appropriate latch actuator may be disabled, including a push bar, which may be prevented from being depressed while the privacy lock is in the privacy configuration.

In some embodiments, the latch is operatively coupled to a lever arm configured to move between a first lever arm position and a second lever arm position. The lever arm may be operatively coupled to a latch actuator of the exit device, such as the push bar, such that actuation of the push bar may move the lever arm from the first lever arm position to the second lever arm position. Movement of the lever arm from the first lever arm position to the second lever arm position may move the latch from the extended latch position to the retracted latch position according to some embodiments.

The exit device includes an indicator configured to indicate a state of the exit device according to some embodiments. For example, the indicator may indicate the exit device is in a privacy configuration or a non-privacy configuration. In some cases, the privacy configuration is associated with one or more latch actuators of the exit device being disabled. For example, in the privacy configuration, a latch actuator, such as the door handle, operatively coupled to the latch and configured to move the latch between the extended configuration in the retracted configuration, may be disabled. The non-privacy configuration may be associated with one or more or all latch actuators of the exit device being enabled. For example, in the one privacy configuration, the door handle and the push bar disposed on a first and second side of an associated door, respectively, may both be enabled to operate the exit device.

In some embodiments, the indicator may include an indicator face including visual indications representative of the state of the exit device. For example, the indicator face may include visual indications for a privacy indication and a non-privacy indication. The indicator face is disposed on and/or within an indicator plate according to some embodiments. The indicator plate is configured to move between a first indicator plate position and a second indicator plate position according to some embodiments. The indicator face is configured to move between a first indicator face position and a second indicator face position according to some embodiments.

The exit device includes an indicator lever configured to move between a first indicator lever position and a second indicator lever position according to some embodiments. The exit device may also include a hub movably coupled to the actuator and the shaft. The hub may also be movably coupled to the indicator lever, such that the indicator lever is configured to move between the first indicator lever position and the second indicator lever position in response to movement of the hub. For example, the hub may be movable between a first hub position and a second hub position, and movement of the hub from the first hub position to the second hub position may move the indicator lever from the first indicator lever position to the second indicator lever position. In some embodiments, the hub is coupled to the privacy actuator such that transitioning the privacy actuator from the non-privacy configuration to the privacy configuration moves the hub. For example, the hub may be coupled to a button, and pressing the button may move the hub. The indicator lever may be movably coupled to the indicator plate. For example, movement of the indicator lever from the first indicator lever position to the second indicator lever position may move the indicator plate from the first indicator plate position to the second indicator plate position. The indicator face may move from the first indicator face position to the second indicator face position in response to movement of the indicator plate from the first indicator plate position to the second indicator plate position.

In some embodiments, the exit device may include an indicator switch operatively coupled to the privacy actuator and the indicator and configured to provide an indication to the indicator indicative of the state of the exit device. For example, the privacy actuator and/or one or more components operatively coupled to the privacy actuator may be configured to engage the indicator switch, and the indicator switch may be configured to detect the state of the exit device based on the privacy actuator and/or the one or more components engaging the indicator switch. In some cases, the indicator may optionally include one or more light sources configured to illuminate at least a portion of the indicator. The one or more light sources may be operatively coupled to a controller configured to control the one or more light sources. The indicator switch may also be operatively coupled to the controller and may be configured to communicate the state of the exit device to the controller. The controller may control the one or more light sources based on the state of the exit device obtained from the indicator switch. The one or more light sources may be used alone or in addition to the indicator face to indicate the state of the exit device. The indicator may also include an indicator window which may be at least partially transparent and configured to display the indication from the indicator. For example, the indicator face and/or the one or more light sources may be visible through the indicator window, thereby providing a visual indication of the state of the exit device. In some embodiments, the indicator window is coupled to the chassis that is configured to house the components of the exit device.

Any appropriate component of the exit device may be biased using one or more biasing elements. For example, the latch may be biased to the extended latch position by a latch biasing element. In another example, the shaft may be biased to the first shaft position (e.g., first shaft a vertical position) by a shaft biasing element. The lever arm may also be biased to the first or second lever arm position using a lever arm biasing element. Any latch or privacy actuator described herein may be biased towards an un-actuated position using an appropriate biasing element. In some embodiments, the catch is movable between a first catch position and a second catch position and is biased towards the second catch position using a catch biasing element. According to some embodiments, the indicator lever, the indicator plate, and/or the indicator face is biased in a direction, such as the first or second indicator lever position, first or second indicator plate position, the first or second indicator face position, respectively, using one or more indicator biasing elements. In some embodiments, the trim lever is biased towards the first trim lever position or the second trim lever position using a trim lever biasing element.

In some embodiments, the exit device includes an override assembly configured to override the state of the exit device. For example, the override assembly may be configured to enable an override the state of the exit device from the privacy configuration to the non-privacy configuration. The override assembly may also be configured to enable an override of the exit device from the non-privacy configuration to the privacy configuration. In some cases, the override assembly is operable via a key or access card. Overriding the state of the exit device may include moving the latch between the extended latch position and the retracted latch position, thereby enabling or disabling operation of the exit device from one or more sides of the exit device and any associated door.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

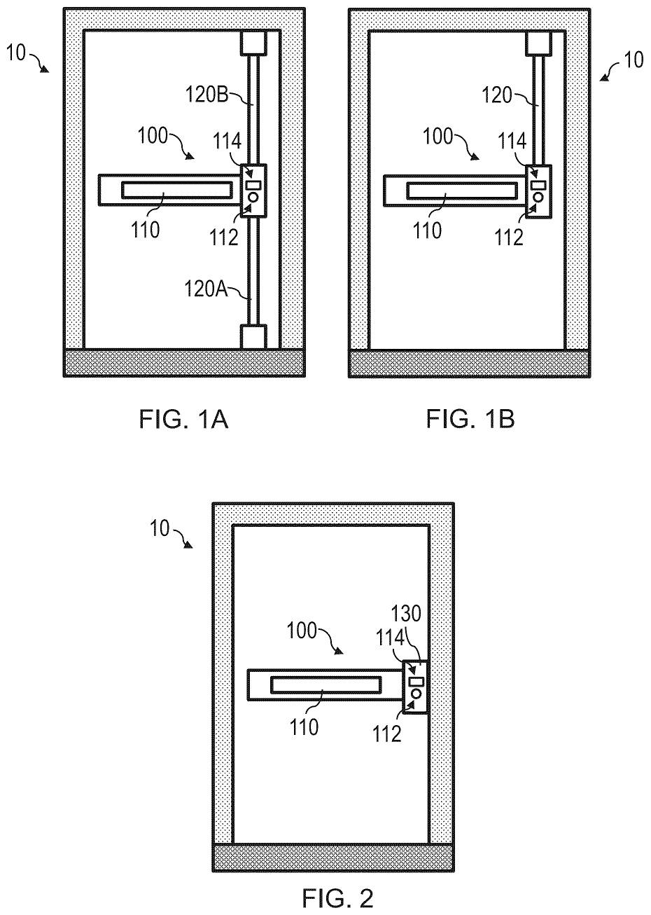

As discussed herein, the exit device is configured to be coupled to a door according to some embodiments. For example, the exit device is shown coupled to a door in the depicted embodiments of FIGS. 1-2. More specifically, a door system 10 includes an exit device 100 having a push bar 110. In the depicted embodiments of FIGS. 1A and 1B, the exit device 100 also includes one or more rods 120 for securing the door. The rod 120 may be operatively coupled to a latch and/or latch assembly, which may be used to secure the door. For example, the push bar 110 may be actuated, and the rod 120 may move a latch or latch assembly to secure the door. Depending on the embodiment, a single rod or multiple rods is be used. For example, in the depicted embodiment of FIG. 1A, the exit device 100 includes two rods 120A, 120B. In the depicted embodiment of FIG. 1A, the rods 120A, and 120B are configured to secure the door on both of an upper and lower portion of a door frame. In another example, such as the depicted embodiment of FIG. 1B, the exit device 100 includes a single rod 120 configured to secure the door on an upper portion of a door frame. In the depicted embodiment of FIG. 2, the exit device includes a latch assembly 130 configured to secure the door on a side portion of the door frame. The latch assembly may include a door latch (e.g., latch or bolt) configured to secure the door via the side portion of the door frame. The exit device 100 may also include a privacy lock 112 and an indicator 114, as described herein and further below. In the depicted embodiment of FIG. 2, the privacy lock 112 in indicator 114 are disposed on the latch assembly 130. It should be understood that the exit device 100 may optionally be formed with the indicator 114. Accordingly, the embodiments described herein, including the depicted embodiments of FIGS. 1A, 1B, and 2 may be formed without the indicator 114.

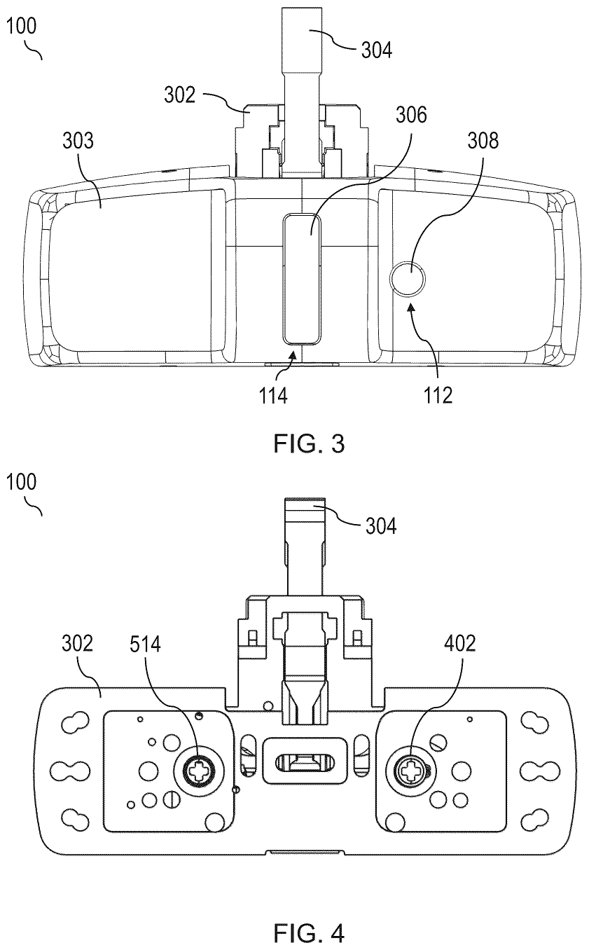

A top view of the exit device 100 is depicted in the embodiment shown in FIG. 3. The exit device 100 may include a base plate 302 which may be couple to and/or configured to support any appropriate component or combination of components of the exit device 100. A chassis 303 may be configured to house any appropriate components or combination of components of the exit device 100. The exit device may include a lever arm 304 which may be movable between a first lever arm position to a second lever arm position. In some embodiments, movement of a push bar operatively coupled to the exit device may move the lever arm 302 from the first lever arm position to the second lever arm position. Movement of the lever arm 302 from the first lever arm position tot eh second lever arm position may move the latch 502 from the extended latch position to the retracted latch position. The lever arm 302 may be configured to rotate about a longitudinal axis of the exit device 100. The indicator 114 may include an indicator window 306 which may be configured to display an indication of the indicator 114. The indicator window 306 may be at least partially transparent to allow any appropriate component or combination of components of the indicator 114 to be seen through the indicator window 306. The privacy lock 112 may include a privacy actuator 308.

In the depicted embodiment of FIG. 3 the privacy actuator 308 is formed as a button, however it should be appreciated that any appropriate actuator, including but not limited to a lever or knob may be used as the privacy actuator 308 as the disclosure is not limited in this fashion. For example, in some embodiments the privacy actuator 308 is formed as a push and turn actuator. The push and turn may be configured to move between a first linear position and a second linear position and rotate between a first rotational position and a second rotational position. The push and turn actuator may be configured to remain in the second linear position in response to movement from the first rotational position to the second rotational position. In some cases, the push and turn actuator is biased to the first linear position and is returned from the second linear position to the first linear position in response to rotation of the push and turn actuator from the second rotational position to the first rotational position. In some cases, the button described herein is formed as a push and turn actuator. In embodiments including a push and turn privacy actuator, the latch actuators of the exit device, such as the push bar and/or door handle, knob, or lever, may not be capable of retracting the latch 502 while the push and turn privacy actuator is in the second linear position and second rotational position. Thus, the privacy actuator is moved to the first rotational position and the first linear position in order to allow the latch actuator to retract the latch. In some embodiments, the privacy actuator 308 includes or is formed as a throw off actuator.

As shown in the depicted embodiment of FIG. 3, indicator window 306 is formed within a rectangular cutout of the chassis 303. However it should be appreciated that the indicator window 306 may be formed in any appropriate geometry, including but not limited to a square, circular, ovular, triangular, or any other appropriate geometry as the disclosure is not limited in this fashion. Indicator window 306 may be formed out of any appropriate material, including but not limited to glass or plastic as the disclosure is not limited in this sense. The indicator 114 will be described further below with respect to proceeding figures.

A bottom view of the exit device 100 is shown in the depicted embodiment of FIG. 4. As previously mentioned, the exit device 100 may include an override assembly configured to enable an override of the state of the exit device. The override assembly may include an override shaft 402 coupled to the base plate 302. The override shaft 402 may be configured to rotate via a key or access card assembly, depending on the embodiment. The override shaft 402 and any other portion of the override assembly may be positioned in any appropriate portion of the exit device as the disclosure is not limited in this sense. As will be discussed further below with respect to proceeding figures, the privacy lock 112 may include a shaft 514 coupled to the base plate 302. In some cases, the override assembly may be operatively coupled to the shaft 514 and may be configured to override the state of the privacy lock 112 via the shaft 514. Either trim lever 518A, 518B may be configured to be moved between the respective first trim lever position and second trim lever position to override the state of the exit device in response to operation of the override assembly as the disclosure is not limited in this sense.

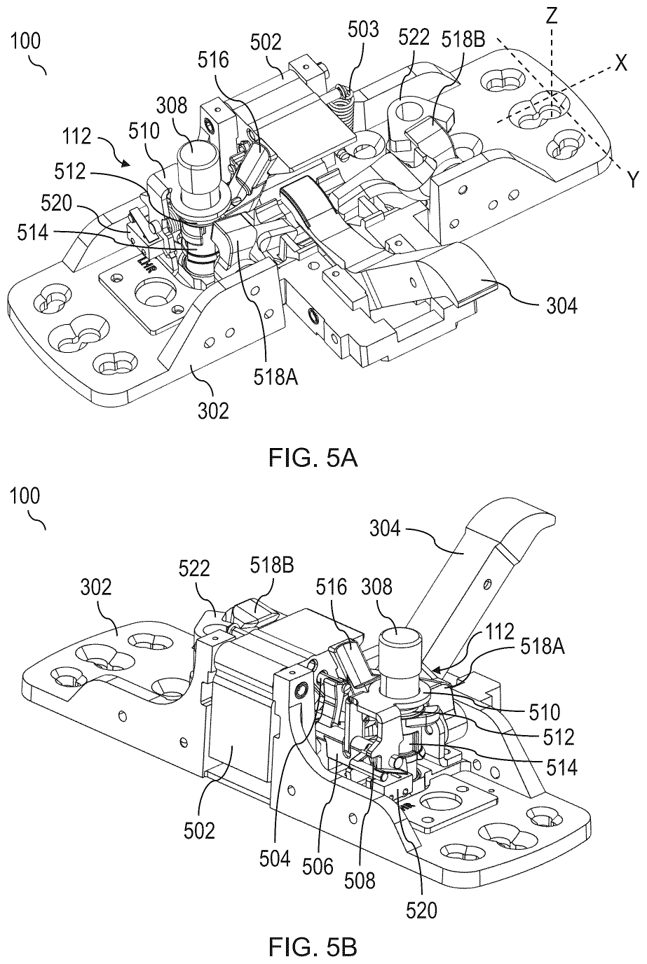

FIGS. 5A and 5B show perspective views of the exit device 100 according to some embodiments. The exit device 100 may include a latch 502 configured to move between a latch extended position and a latch retracted position. In the depicted embodiment of FIG. 5A, three axes labeled “X”, “Y”, and “Z” are shown. The “X” axis represents a longitudinal axis of the exit device 100. The “Y” axis represents a transverse axis of the exit device 100. The “Z” axis represents a vertical axis of the exit device 100. In the depicted embodiments of FIGS. 5A and 5B the latch 502 is shown in the latch retracted position. The latch 502 may be configured to rotate relative to the transverse axis of the exit device 100. In some embodiments, the latch 502 is configured to rotate between the latch extended position and the latch retracted position. The latch 502 may optionally be biased by a latch biasing element 503. In the depicted embodiment of FIG. 5A the latch biasing element 503 is formed as a spring configured to bias the latch 502 towards the latch extended position. The privacy lock 112 may include a privacy lock bracket 510, which may be coupled to the base plate 302 configured to support the privacy lock 112.

As previously mentioned, the privacy lock 112 may include a privacy actuator 308. In the depicted embodiments of the figures, the privacy actuator 308 is formed as a button. The privacy actuator 308 may be configured to transition between a non-privacy configuration to a privacy configuration. In some embodiments, the privacy actuator 308 is configured to move between a non-privacy position to a privacy position. For example, the button 308 may be configured to move between a first button position (e.g., unpressed position) and a second button position (e.g., pressed position). In some embodiments, the button 308 is configured to move between the first button position and the second button position along the vertical axis. Pressing the button 308 may move the button from the first button position to the second button position.

In some embodiments, such as the depicted embodiment of FIG. 5B, a latch pin 504 is coupled to the latch 502. The latch pin 504 may be configured to engage a portion of a catch 506, described further below. The privacy lock 112 may include a hub 512 operatively coupled to the privacy actuator 308. The hub 512 may be movable between a first hub position and a second hub position. The hub may be configured to move between the first hub position and the second hub position along the vertical axis. In the depicted embodiments of the figures, the hub 512 is configured to move linearly between the first hub position and the second hub position. The privacy lock 112 may also include a shaft 514 operatively coupled to the hub 512 and/or the privacy actuator 308. The shaft 514 may be movable between a first shaft position and a second shaft position. In the depicted embodiments of the figures the shaft 514 is linearly movable between a first shaft linear position and a second shaft linear position. The shaft may be configured to move between the first shaft linear position and the second shaft linear position along the vertical axis. The shaft 514 may be rotatable between a first shaft rotational position and a second shaft rotational position. In some embodiments, the shaft 514 is configured to rotate between the first shaft rotational position and the second shaft rotational position about the vertical axis. The privacy actuator 308 may be actuated to move the hub from the first hub position to the second hub position, and the shaft from the first shaft position to the second shaft position. An example of actuating the privacy actuator includes pressing the button 308 to move the button from the first button position to the second button position.

The shaft 514 is operatively coupled to a latch actuator according to some embodiments. For example, the shaft 514 may be coupled to a rotatable door handle, or any other appropriate rotatable latch actuator. The shaft 514 may rotate in response to rotation of the rotatable door handle. The exit device 100 may include one or more trim levers 518. For example, in the depicted embodiments of FIG. 5A, the exit device may include trim levers 518A and 518B. Trim lever 518A may be selectively coupled to the shaft 514. For example, trim lever 518A may be movably coupled to the shaft 514 while the shaft is in the first shaft position (e.g., first shaft linear position), such that rotation of the shaft 514 from the first shaft rotational position to the second shaft rotational position moves the trim lever 518A from a first trim lever rotational position to a second trim lever rotational position. The trim levers 518A, 518B may be configured to move between the first trim lever rotational position to the second trim lever rotational position about the transverse axis. The trim levers 518 may be movably coupled to the latch 502. For example, the latch 502 may move from the latch extended position to the latch retracted position in response to the trim lever 518 moving from the first trim lever position to the second trim lever position. In some embodiments, the trim lever 518 is biased towards the first trim lever position or the second trim lever position using a trim lever biasing element. In the depicted embodiment of FIG. 5A, the trim levers 518A, 518B are rotatable and are configured to rotate between their respective first trim lever position and second trim lever position. As will be described further below with respect to proceeding figures, one or more portions of the shaft 514 may be configured to engage the trim lever 518A to rotate the trim lever 518A.

One or more portions of the privacy lock 112, such as the shaft 514, may function as a coupling configured to operatively couple a latch actuator, such as a door handle, with the latch 502. In some embodiments, including the depicted embodiment of FIG. 5A, the shaft 514 may operatively couple the door handle with the latch 502 via the trim lever 518A. The coupling may be configured to selectively couple the latch actuator with the latch 502. For example, transitioning the privacy actuator 302 from a non-privacy configuration to a privacy configuration may decouple the coupling from the latch 502, thereby the coupling the latch actuator from the latch 502. As previously described above, the coupling the latch actuator from the latch 502 may serve to prevent operation of the exit device from one side of the exit device and an associated door, thereby preventing access to an associated space from the one side of the exit device and the associated door. In an example, a user located exterior to the room they be unable to operate a latch actuator of the exit device while a user located interior to the room may be able to operate a latch actuator of the exit device while the privacy lock is in the privacy configuration.

In some embodiments, the exit device 100 includes a catch 506. The catch 506 is configured to selectively engage one or more portions of the privacy lock 112 to maintain respective positions of the one or more portions of the privacy lock 112. For example, the catch 506 may be configured to selectively engage the shaft 514 to maintain the position of the shaft 514. Specifically, the catch 506 may be configured to engage the shaft 514 while the shaft 514 is in the second shaft linear position to maintain a shaft 514 and the second shaft linear position. In some embodiments, the catch is configured to disengage the shaft 514 while the shop 514 is in the first shaft linear position. In some cases, a portion of the catch 506 may still contact a portion of the shaft 514 while the catch 506 is disengaged with the shaft 514. In some embodiments, the catch 506 is movably coupled to and supported by the privacy lock bracket 510 and/or the base plate 302. The catch 506 is rotatably coupled to the privacy lock bracket 510 and/or the base plate 302 according to some embodiments. For example, the catch 506 may be rotatable between a first catch position and a second catch position. In some cases, the catch 506 is rotatable between a disengaged catch position and an engaged catch position. The catch 506 may be configured to rotate between the disengaged catch position and the engaged catch position about the longitudinal axis. The catch 506 is biased towards the engaged catch position using a catch biasing element 508 according to some embodiments.

As previously discussed, the latch 502 may be operatively coupled to a latch actuator, such as a push bar, and may include the latch pin 504 configured to engage a portion of the catch 506. Accordingly, actuation of the latch actuator may move the latch 502 and the latch pin 504, thereby moving the catch 506. For example, the push bar may be moved from a resting position to a depressed position, thereby moving the latch 502 from the extended latch position to the retracted latch position, thereby moving the latch pin 504 to move the catch 506 from the engaged catch position to the disengaged catch position. The privacy lock 112 may be configured to transition from the privacy configuration to the non-privacy configuration in response to movement of the catch 506 from the engaged catch position to the disengaged catch position. For example, the catch 506 may maintain the shaft 514 and the second shaft linear position by engaging a portion of the shaft 514 while in the engaged catch position, and may move to disengage the portion of the shaft by 14 while in the disengaged catch position, thereby enabling the shaft 514 to move to the first shaft position, optionally via a shaft biasing element configured to bias the shaft 514 towards the first shaft position.

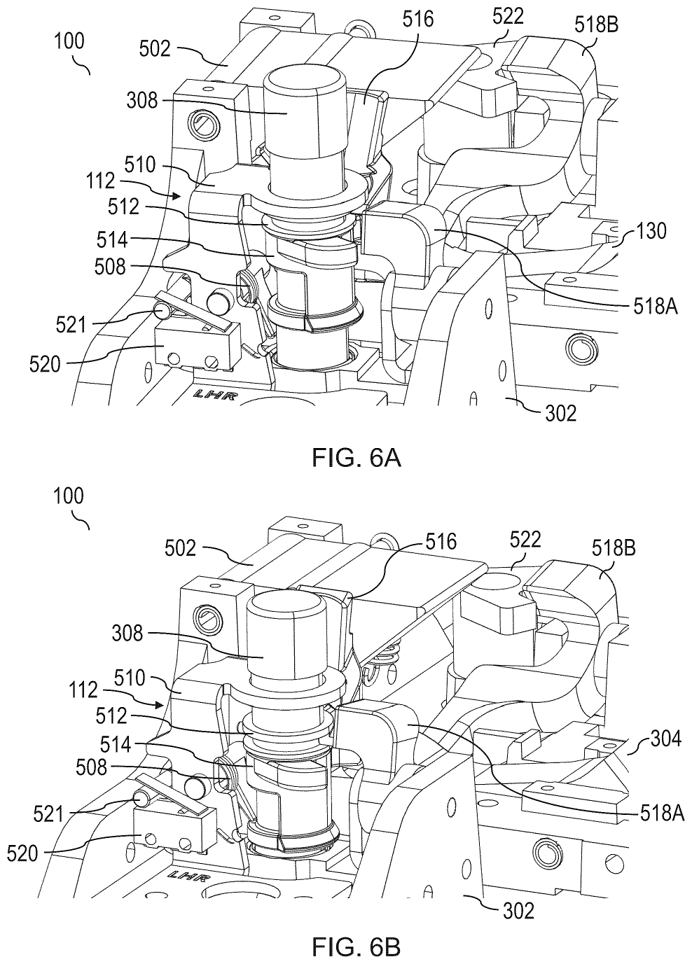

As best shown in the depicted embodiments of FIGS. 6A and 6B, the exit device 100 may include an indicator switch 520. As discussed further elsewhere, the indicator switch 520 may be configured to communicate with a controller. For example, the indicator switch may be configured to detect a state of the exit device and communicate the detected state of the exit device with the controller. Any appropriate portion of the privacy lock 112 may be configured to engage the indicator switch 520, and the indicator switch 520 may be configured to detect the state of the exit device 100 based at least in part on the portion of the privacy lock 112 engaging the indicator switch. For example, a catch projection 521 of the catch 506 may be configured to engage the indicator switch 520, and the indicator switch 520 may be configured to detect the state of the exit device 100 based whether or how the catch projection 521 engages the indicator switch 520. In some embodiments, the indicator switch 520 detects the state of the exit device (e.g., privacy configuration or non-privacy configuration) based on whether the catch projection 521 contacts the indicator switch 520. The catch projection 521, may, for example, rotate with the catch 506 in response to the latch pin 504 of the latch 502 rotating the catch 506 to contact the indicator switch, thereby enabling the indicator switch 520 to detect that the exit device 100 is in the non-privacy configuration.

FIG. 6A illustrates the privacy lock 112 in a non-privacy configuration according to some embodiments. The button 308 is in the unactuated, first button position, the hub 512 is in the first hub position, the shaft 514 is in the first shaft position, the catch 506 is in the disengaged catch position, and the indicator lever 516 is in the first indicator lever position. The shaft 514 is configured to rotate and engage the trim lever 518A in the depicted embodiment of FIG. 6B. In the depicted embodiment of FIG. 6B, the privacy lock 112 in a privacy configuration according to some embodiments. The button 308 is in the actuated, second button position, the hub 512 is in the second hub position, the shaft 514 is in the second shaft position, the catch 506 is in the engaged catch position, and the indicator lever 516 is in the second indicator lever position. The shaft 514 is configured such that the shaft 514 may rotate without engaging the trim lever 518A in the depicted embodiment of FIG. 6B.

In some embodiments, the override assembly as previously discussed may include an override trim lever hub 522, which is coupled to or integrally formed with the shaft 402. The override trim lever hub 522 may be configured move between a first override trim lever hub position and a second override trim lever hub position. For example, the override trim lever hub may be configured to rotate from a first override trim lever hub position to a second override trim lever hub position to move an override trim lever 518B from a first override trim lever position to a second override trim lever position. The latch 502 may be configured to move from the latch extended position to the latch retracted position in response to movement of the override trim lever 518B from the first override trim lever position to the second override trim lever position. As previously discussed, the override trim lever hub 522 and/or the override shaft 402 may be rotatable via a key or access card. The trim lever hub 522 and/or the override shaft 402 may be configured to rotate about the vertical axis. In an example of operation of the override assembly, the privacy lock may be in the privacy configuration, maintaining the latch 502 and the latch extended position and the override assembly may be operated to rotate the trim lever hub 522 to rotate the trim lever 518B to move the latch from the latch extended position to the latch retracted position.

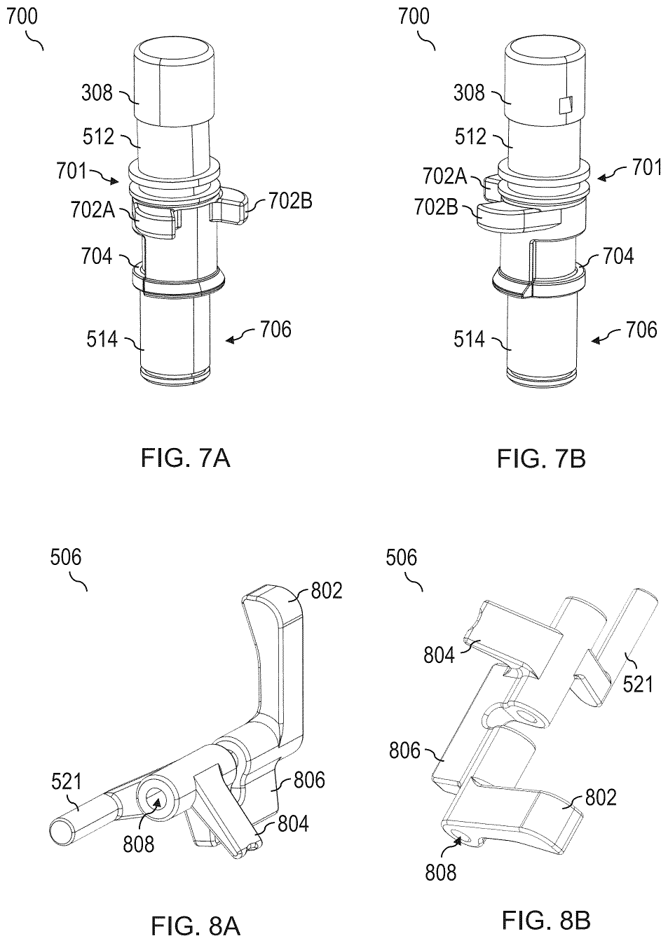

FIGS. 7A and 7B show a privacy actuator assembly 700 according to some embodiments. As previously described, the privacy actuator 308 may be operatively coupled to a hub 512. The hub 512 may include a hub groove 701 configured to receive a portion of an indicator lever 516, as will be described further with respect to proceeding figures. In the depicted embodiment of FIG. 7A and 7B the hub groove is formed between two radially projecting features of the hub 512. However, the hub groove 701 may be formed in any appropriate geometry as the disclosure is not limited in this sense. The privacy actuator assembly 700 may also include the shaft 514. The shaft 514 may include one or more features configured to engage with the trim lever 518. For example, the shaft 514 may include one or more shaft projection 702 configured to engage the trim lever 518. In some cases, the shaft projection 702 is configured to engage the trim lever 518 as the shaft 514 rotates between the first shaft rotational position and the second shaft rotational position.

In the depicted embodiment of FIGS. 7A and 7B, the shaft includes a first shaft projection 702A and a second shaft projection 702B. The shaft projections 702A, 702B may be configured to engage the trim lever 518, where the first shaft projection 702A may engage the trim lever 518 as the shaft rotates in a first direction, and the second shaft projection 702B engages the trim lever 518 as the shaft rotates in a second direction. For example, the first shaft projection 702A may be configured to engage the trim lever as the shaft 514 rotates from the first shaft rotational position to the second shaft rotational position, and the second shaft projection 702B may be configured to engage the trim lever 518 as the shaft rotates from the second shaft rotational position to the first shaft rotational position. The shaft projections 702 may be formed on any appropriate portion of the privacy actuator assembly 700, including but not limited to the hub 512, as the disclosure is not limited in this sense.

The shaft 514 may also include a shaft receptacle 704 configured to receive a portion of the catch 506 while the catch 506 is in the catch engaged position. In the depicted embodiment of FIGS. 7A and 7B, the shaft receptacle 704 is formed as a radial recess having a bottom surface in the shaft 514, however the shaft receptacle 704 may be formed in any appropriate geometry as the disclosure is not limited in this sense. The shaft receptacle 704 may also be formed in any appropriate portion of the privacy actuator assembly 700, including but not limited to the hub 512, as the disclosure is not limited in this sense. The shaft 514 may also include a lower shaft portion 706 which may be configured to be received by the base plate 302. In embodiments where the privacy actuator assembly is biased in a direction, the biasing element is coupled to the lower shaft portion 706, although the shaft biasing element may be coupled to any appropriate portion of the privacy actuator assembly 700 as the disclosure is not limited in this sense.

FIGS. 8A and 8B show perspective views of the catch 506 according to some embodiments. The catch 506 may include the catch projection 521, a catch cam 802, a catch stopper 804, a catch body 806, and a catch channel 808. The catch cam 802 may be configured to engage the latch pin 504 as previously described. The catch stopper 804 may be configured to engage the privacy actuator assembly 700. For example, the catch stopper may be configured to engage the shaft receptacle 704 of the shaft 514 when the catch 506 is in the catch engaged position to maintain the shaft 514 in the second shaft position. The catch stopper may optionally include a rounded geometry at a distal end of the catch stopper 804 as to engage a rounded geometry of the shaft 514. The catch 506 may be configured to rotate about the catch channel 808. For example, the catch channel 808 may be rotatably coupled to the base plate 302 and/or the privacy actuator bracket 510.

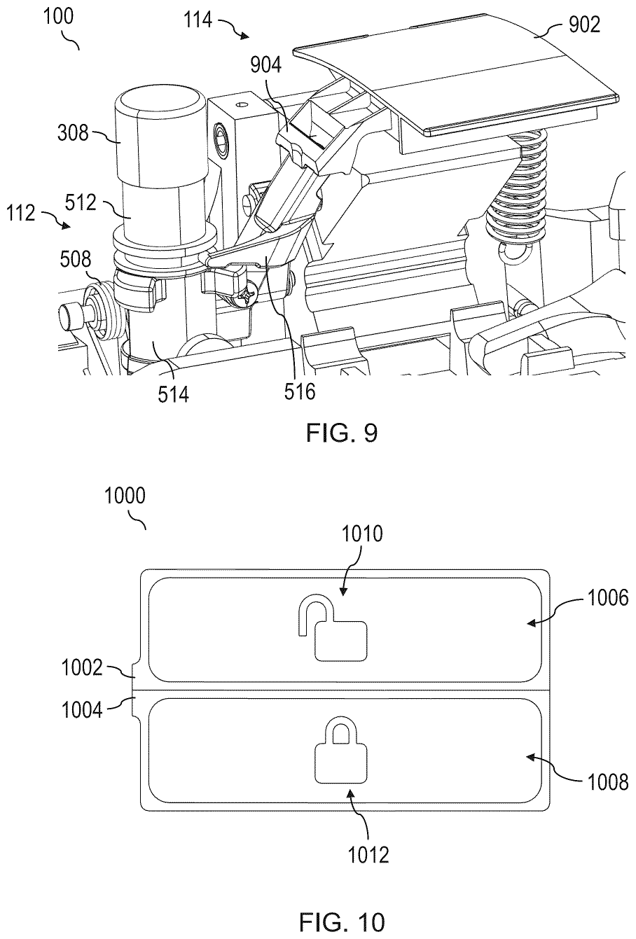

As previously discussed, the exit device 100 may include an indicator 114. The indicator 114 may include a status indicator plate 902 coupled to or integrally formed with a status indicator frame 904. The status indicator frame 904 may be movably coupled to the indicator lever 516. The indicator lever 516 may be coupled to one or more portions of the privacy actuator assembly 700, such as the hub 512. For example, a portion, such as a projection (e.g., tab) of the indicator lever 516 may be configured to engage the groove 701 of the hub 512. The portion of the indicator lever 516 may move within the groove 701 as the hub 512 moves with the other elements of the privacy actuator assembly 700. The indicator lever 516 may be configured to rotate between a first indicator lever position and a second indicator lever position, thereby moving the status indicator plate 902 from the first status indicator plate position to the second status indicator plate position, optionally via the status indicator frame 904. For example, the button 308 may be pressed from the first button position downward relative to the perspective of FIG. 9 toward the second button position, thereby moving the portion of the indicator lever 516 within the groove 701 and causing the indicator lever 516 to rotate from the first indicator lever position towards the second indicator lever position. The indicator lever 516 may be configured to rotate between the first indicator lever position and the second indicator lever position about the transverse axis. In the depicted embodiment of FIG. 9, the trim lever 518A and privacy lock bracket 510 are not shown to more clearly illustrate components of the indicator 114. Rotation of the indicator lever 516 from the first indicator lever position to the second indicator lever position may move the status indicator plate 902 from the first status indicator plate position to the second status indicator plate position, which may move a status indicator face 1000, such as the status indicator face 1000 shown in the depicted embodiment of FIG. 10, coupled thereto from a first status indicator face position to a second status indicator face position. The indicator plate and/or the status indicator face may be configured to move along a transverse axis of the exit device 100. In the first status indicator face position, the status indicator face 1000 may be configured to provide an indication that the exit device 100 and/or privacy lock 112 are in a non-privacy/unsheltered configuration. In the second status indicator face position, the status indicator face 1000 may be configured to provide an indication that the exit device 100 and/or privacy lock 112 are in a privacy/sheltered configuration.

The status indicator face 1000 may include a first status indicator face portion 1002 and a second status indicator face portion 1004. The first status indicator portion 1002 may include a first indication 1006, which may optionally include a first indication icon 1010. The second status indicator portion 1004 may include a second indication 1008, which may optionally include a second indication icon 1012. In the depicted embodiment of FIG. 10, the status indicator 1000, first and second status indicator face portions 1002, 1004, and first and second indications 1006, 1008 are formed with rectangular geometries, however is should be appreciated that the status indicator 1000, first and second status indicator face portions 1002, 1004, and first and second indications 1006, 1008 may be formed in any appropriate geometry or combination of geometries, including but not limited to square, triangular, circular, ovular, and any other appropriate geometry as the disclosure is not limited in this sense. The first indication icon 1010 and the second indication icon 1012 are shown in the depicted embodiment of FIG. 10 as an unlocked lock and a locked lock, respectively, however it should be appreciated that any appropriate icon may be used as an indication as the disclosure is not limited in this sense whatsoever. The status indicator face 1000 may also provide the indication using one or more of colors, shapes, numbers, decals, letters, or any other appropriate visual indication in combination with the icons or alone as the disclosure is not limited in this sense.

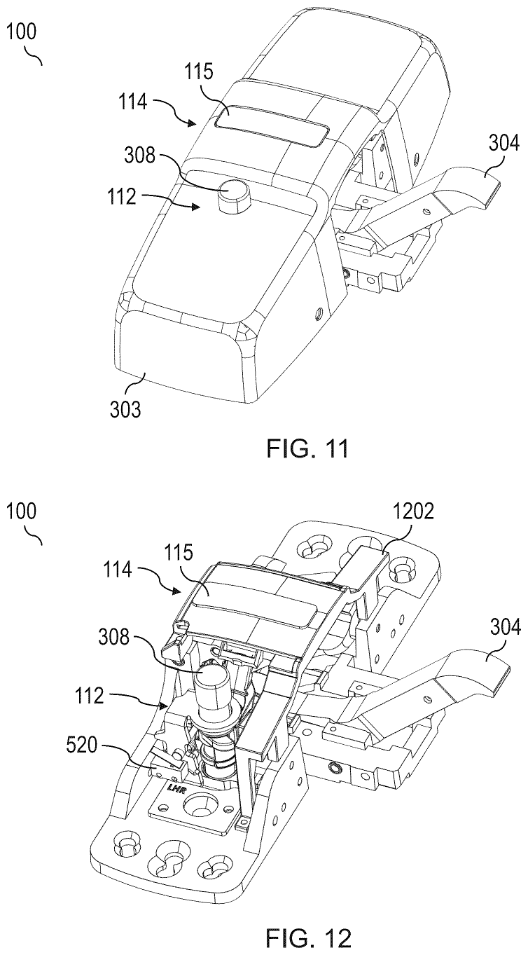

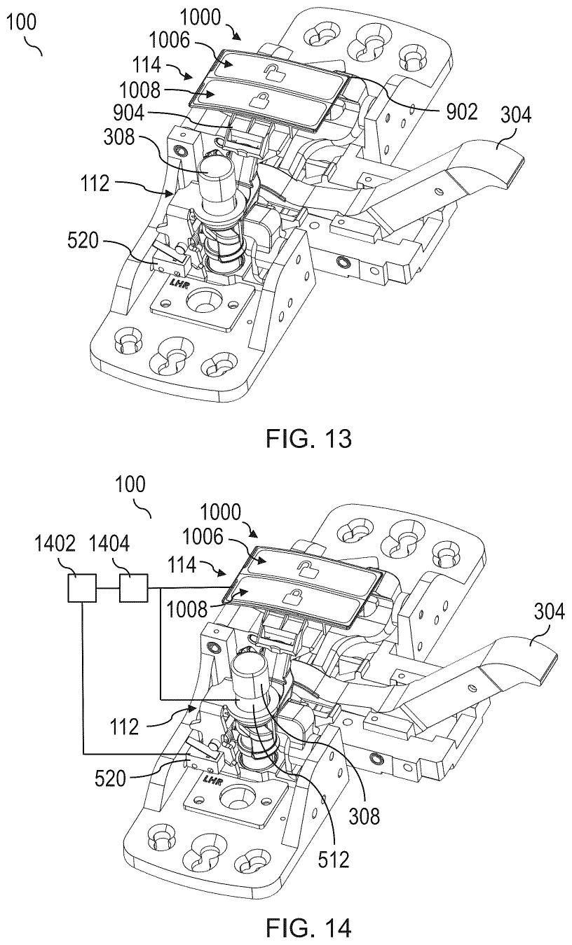

FIGS. 11-14 show perspective views of the exit device 100 according to some embodiments. FIG. 12 shows the exit device with the chassis 303 not shown to illustrate an indicator support structure 1202 of the indicator 114 according to some embodiments. FIG. 13 shows the exit device 100 with the chassis 303 and the indicator support structure 1202 not shown to illustrate the status indicator plate 902, status indicator frame 904, and status indicator face 1000 of the indicator 114 according to some embodiments. FIG. 14 shows the exit device 100 with the chassis 303 and the indicator support structure 1202 not shown to illustrate the status indicator plate 902, status indicator frame 904, and status indicator face 1000 of the indicator 114 according to some embodiments. The depicted embodiment of FIG. 14 also includes a controller 1402 and a light source 1404. The controller 1402 is operatively coupled to the indicator switch 520 and the light source 1404 in the depicted embodiment of FIG. 14. As previously discussed, the indicator switch 520 may be configured to communicate information regarding the detected state of the exit device 100 with the controller 1402. The controller 1402 may be configured to control the light source 1402, optionally based at least in part on the information communicated to the controller 1402 from the indicator switch 520. The light source 1404 may include any appropriate quantity of light sources coupled to and configured to illuminate any appropriate portion of the exit device 100 as the disclosure is not limited in this sense. For example, the light source 1404 may be configured to selectively illuminate the status indicator face 1000, the hub 512, the privacy actuator 308, and/or the status indicator window 306.

The light source may also be configured to illuminate any portion of the exit device 100 and/or associated door as the disclosure is not limited in this sense. For example, the light source may be configured to illuminate at least a portion of the exit device and/or associated door on one or both sides of the door (e.g., interior and/or exterior sides). The indicator 114 as described herein may optionally include or be formed as a display, such as an LED screen configured to display indications associated with the state of the exit device 100. In some cases, the exit device 100 may include a display configured to provide an indication associated with the state of the exit device disposed on both sides of an associated door.

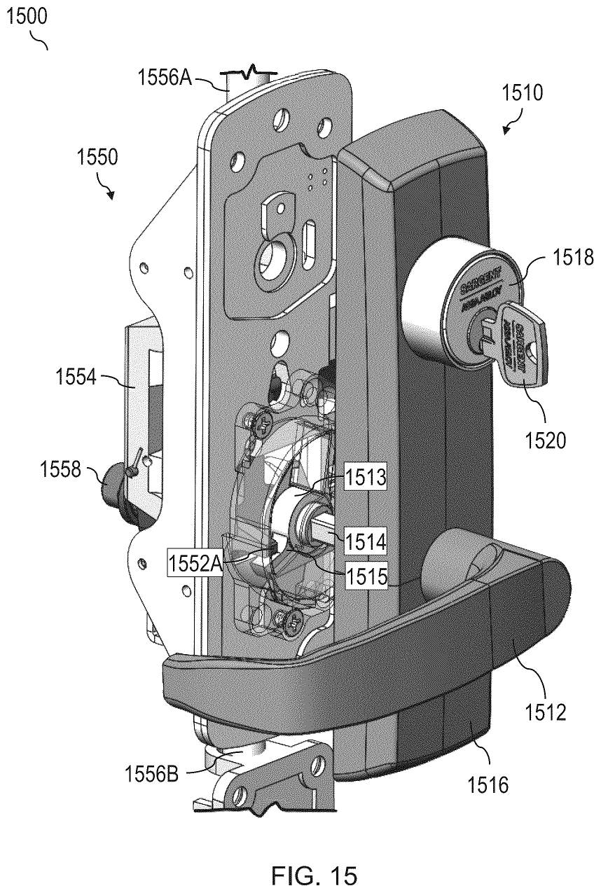

FIG. 15 shows a perspective view of an exit device 1500 including a handle on a first side 1510 of the exit device and a privacy lock on a second side 1550 of the exit device according to some embodiments. The first side 1510 may be disposed on a first side, e.g., an exterior side, of an associated door and the second side 1550 may be disposed on a second side, e.g., an interior side, of the door. The first side 1510 may include a handle 1512 or other appropriate actuator, such as a knob, push bar, or any other appropriate actuator as the disclosure is not limited to a particular actuator. The handle 1512 may be operatively coupled with a linking shaft 1514 and may be configured such that movement, e.g., rotation, of the handle 1512 may move the linking shaft 1514. For example, the linking shaft 1514 may be configured to rotate between a first linking shaft position and a second linking shaft position. Rotation of the handle 1512 from a first handle position to a second handle position may rotate the linking shaft 1514 from the first linking shaft position to the second linking shaft position. The linking shaft 1514 may operatively couple the first side 1510 with the second side 1550, as discussed further below.

In some embodiments, the first side 1510 includes a lock cylinder 1518 which can be operated, for example, with a key 1520. The lock cylinder 1518 may be a part of or otherwise operatively coupled to an override mechanism of the exit device 1500, which may enable a user to override a state of the exit device 1500. For example, the override mechanism may be configured to transition the exit device 1500 from a privacy configuration to a non-privacy configuration and/or transition the exit device 1500 from the non-privacy configuration to the privacy configuration. The first side 1510 may include a chassis 1516 configured to at least partially house one or more components of the first side 1510. As shown in the depicted embodiment of FIG. 15, the handle 1512 and the lock cylinder 1518 are coupled to the chassis 1516.

The linking shaft 1514 may be coupled to a hub 1513 and may be configured such that movement of the linking shaft 1514 moves the hub 1513. The hub 1513 may include one or more hub projections 1515 which may be configured to move in conjunction with the hub 1513. For example, a hub projection 1515 may be configured to move, e.g., rotate, between a first hub projection position and a second hub projection position. As such, rotation of the handle 1512 between the first handle position and the second handle position may rotate the hub projection 1515 between the first hub projection position and the second hub projection position. Movement of the hub projection 1515 may move one or more components of the second side 1550. For example, the hub projection 1515 may be movably coupled with one or more slide projections 1552A, 1552B (slide projection 1552B not shown in the depicted embodiment of FIG. 15) of the exit device 1500. In some embodiments, movement of the hub projection 1515 from the first hub projection position to the second hub projection position moves the slide projection 1552A and/or slide projection 1552B from a first slide projection position to a second slide projection position. Movement of the slide projections 1552A, 1552B from the first slide projection position to the second slide projection position may correspond with movement of a slide (not shown in the depicted embodiment of FIG. 15) from a first slide position to a second slide position. As will be discussed further below, while the exit device 1500 is in the non-privacy configuration, movement of the slide from the first slide position to the second slide position may retract a latch of the exit device 1500.

The exit device 1500 may be configured to retract one or more latches of the exit device 1500 via one or more rods 1556A, 1556B. For example, the exit device may be configured as shown in the depicted embodiments of FIGS. 1A and 1B to include one or more latch assemblies having a rod to operatively couple of the exit device to a door frame. The one or more rods 1556A, 1556B may be movably coupled to a latch slide 1554. In some embodiments, the latch slide 1554 is movable between a first latch slide position and a second latch slide position. Movement of the latch slide 1554 from the first latch slide position to the second latch slide position may move the one or more rods 1556A, 1556B to retract one or more latches of the exit device 1500 which are operatively coupled to the one or more rods 1556A, 1556B. For example, movement of the latch slide 1554 from the first latch slide position to the second latch slide position may move the rod 1556A from a first rod position to a second rod position, which may move a latch of the exit device 1500 from an extended latch position to a retracted latch position. As discussed herein, the privacy lock of the exit device 1500 may include a privacy actuator, such as a button 1558 as shown in the depicted embodiment of FIG. 15. The button 1558 may be movable between a first button position and a second button position. For example, a user may press the button 1558, which may move the button from the first button position to the second button position. Movement of the button 1558 from the first button position to the second button position may transition the privacy lock from the non-privacy configuration to the privacy configuration.

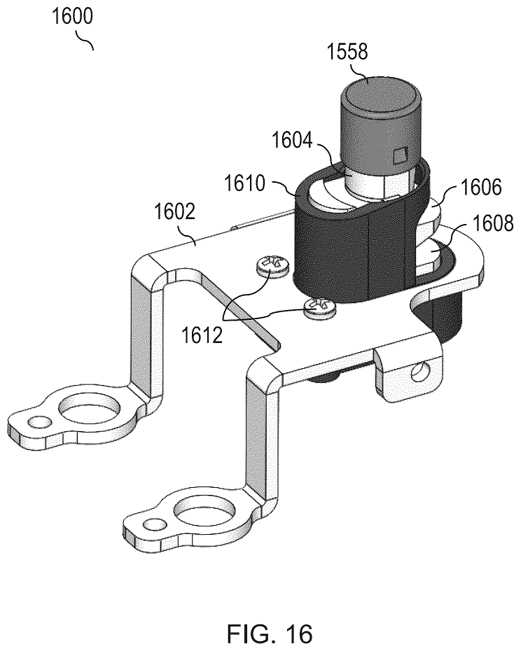

The depicted embodiment of FIG. 16 shows a privacy actuator assembly 1600 according to some embodiments. The privacy actuator assembly 1600 may include the button 1558 coupled to a privacy actuator body 1604 which may include a first privacy actuator body surface 1606 and a second privacy actuator body surface 1608. In the depicted embodiment of FIG. 16, the first actuator body surface 1606 is coupled to an angled surface which may be positioned between the first privacy actuator body surface 1606 and the second privacy actuator body surface 1608. The button 1558 and the privacy actuator body 1604 may be coupled in movement such that movement of the button 1558 moves the privacy actuator body 1604. The privacy actuator body 1604 may optionally be housed within a privacy actuator housing 1610. In some embodiments, the privacy actuator housing 1610 and/or the privacy actuator body 1604 is coupled to other portions of the exit device 1500 such as a chassis of the exit device via a privacy actuator bracket 1602. The privacy actuator housing 1610 may be coupled to the privacy actuator bracket 1602 by any appropriate means, such as one or more fasteners 1612, including but not limited to one or more screws or bolts as the disclosure is not limited in this fashion. The privacy actuator body 1604 may be configured to move within the privacy actuator housing 1610.

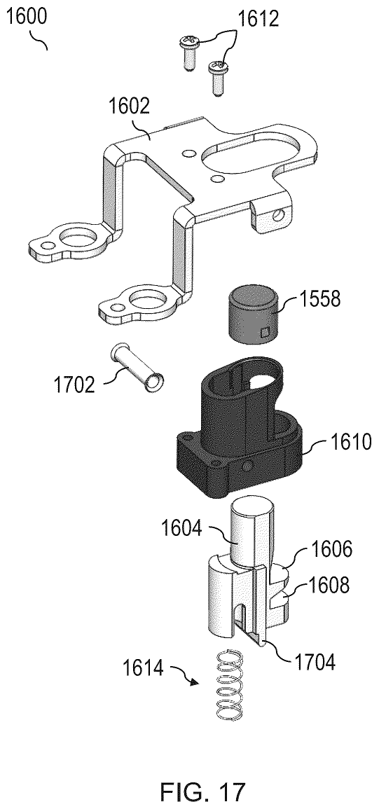

In some embodiments, the button 1558 is biased towards the first button position. For example, a biasing element 1614, e.g., a spring, as shown in the depicted embodiment of FIG. 17 may be configured to bias the button 1558 towards the first button position. The biasing element 1614 may be housed at least partially within one or both of the privacy actuator body 1604 and the privacy actuator housing 1610. In some cases, a tube 1702 is coupled to the privacy actuator housing 1610 and is configured to support the biasing element 1614. The privacy actuator body 1604 may include a button projection 1704 such as in the depicted embodiment of FIG. 17. In the depicted embodiment of FIG. 17, the button projection 1704 is formed on a bottom portion of the privacy actuator body 1604 and includes a rounded end surface. However, the button projection 1704 may be formed in any appropriate shape, including but not limited to an end surface with a rounded, rectangular, and/or triangular shape as the disclosure is not limited in this sense.

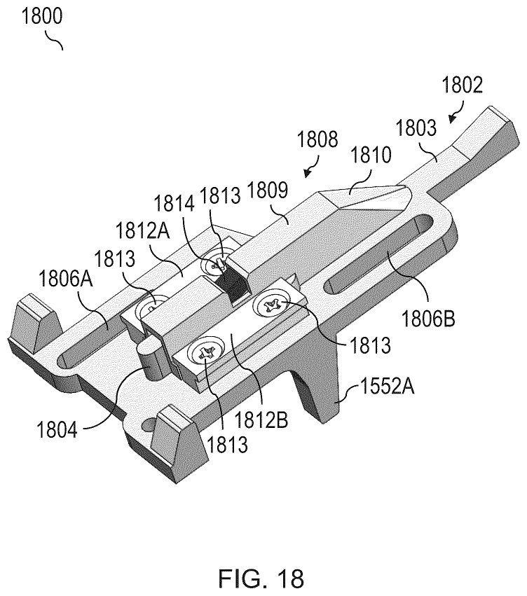

FIG. 18 shows a perspective view of a sliding assembly 1800 according to some embodiments. The sliding assembly 1800 may comprise a slide 1802 movably coupled to a block 1808. The block 1808 may comprise a block body 1809 which may include a block lift surface 1810. The block 1808 may be configured to move, e.g., slide, along a slide body 1803 of the slide 1802. For example, the block 1808 may be configured to move between a first block position and a second block position. In the depicted embodiment of FIG. 18, the block 1808 is movably coupled to the slide 1802 via rails 1812A, 1812B. However, the block 1808 may be movably coupled to the slide 1802 by ball bearings or any other appropriate mechanisms to enable movement of the block 1808 relative to the slide 1802 as the disclosure is not limited in this sense. The rails 1812A, 1812B may be coupled to the slide body 1803, for example, with one or more fasteners 1813, including but not limited to one or more screws or bolts. In the depicted embodiment of FIG. 18, the block 1808 is also configured to slide along a slide hub 1804 formed on the slide body 1803. The slide body 1803 may include one or more slots 1806A, 1806B configured to enable sliding movement of the slide 1802 between the first slide position and the second slide position. The sliding assembly 1800 may also include a stop lever 1814 movable between a coupled position and a decoupled position as discussed herein. In the depicted embodiment of FIG. 18, the stop lever 1814 is shown in the coupled position. The slide 1802 may include one or more slide projections 1552A, which may be formed on the slide body 1803.

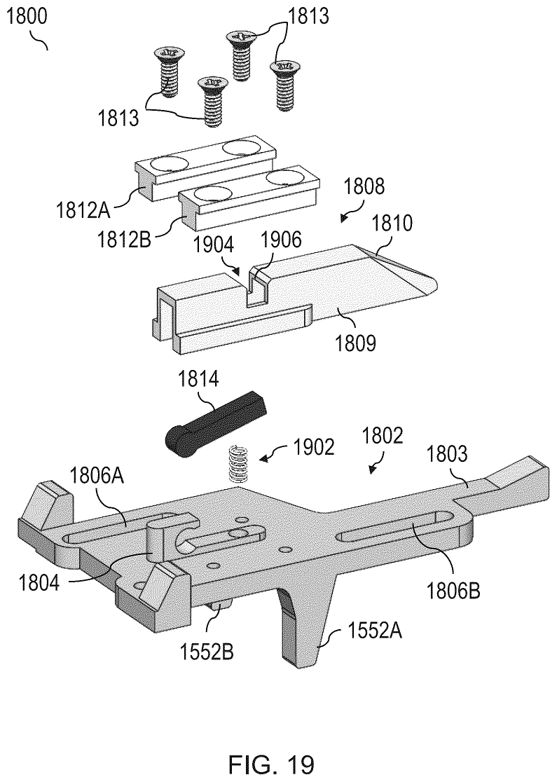

The stop lever 1814 may be movably, e.g., rotatably, coupled to the slide 1802, for example via the slide hub 1804. As shown in the depicted embodiment of FIG. 19, the sliding assembly 1800 may include a stop lever biasing element 1902, which may be configured to bias the stop lever 1814 to the coupled position. The stop lever biasing element 1902 may be at least partially housed in the slide body 1803. In some embodiments, the block 1808 includes a block access port 1904 configured to receive the button projection 1704 as discussed further below. The block access port 1904, or other portion of the block 1808, may include a movement coupling surface 1906. The movement coupling surface 1906 may be configured to contact the stop lever 1814 while the stop lever 1814 is in the coupled position. As such, while the stop lever 1814 contacts the movement coupling surface 1906, movement of the block 1808 and the slide 1802 may be coupled with one another.

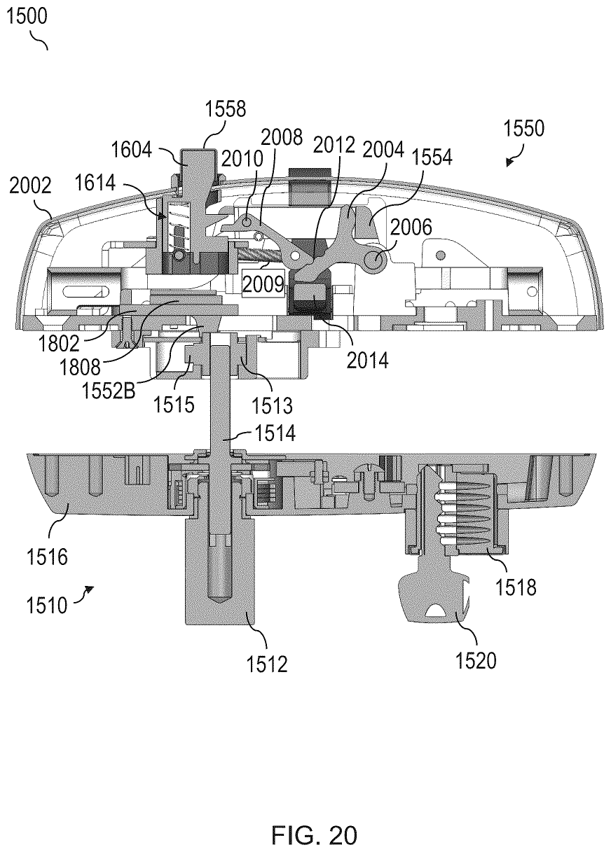

FIG. 20 shows a cross-sectional view of the exit device 1500 according to some embodiments. The second side 1550 of the exit device 1500 may be at least partially or entirely housed within a chassis 2002, such as in the depicted embodiment of FIG. 20. As previously described, the latch slide 1554 may be configured to move from a first latch slide position to a second latch slide position to retract one or more latches of the exit device 1500. The exit device 1500 may include a slide lever 2004 movable between a first slide lever position and a second slide lever position. For example, the slide lever 2004 may be configured to rotate between the first slide lever position and the second slide lever position about a slide lever pivot 2006. Movement of the slide lever 2004 from the first slide lever position to the second slide lever position may move the latch slide 1554 from the first latch slide position to the second latch slide position. The slide lever 2004 may include one or more grooves 2012 configured to interact with, e.g., engage, a guard 2008. The guard 2008 may be configured to prevent tampering with the exit device 1500, for example by preventing retraction of the latch when a user attempts to force one or both of the rods 1556A, 1556B to move to retract the latch. The guard 2008 may be configured to rotate about a guard pivot 2010. The guard 2008 may be coupled to the latch slide 1554, and may be configured to move with the latch slide 1554. In some cases, the guard 2008 is biased towards a direction of movement by a guard biasing element 2009. For example, the guard 2008 may be biased towards a guarded position, e.g., where the guard 2008 is engaged with one or more of the grooves 2012 of the slide lever 2004 by the guard biasing element 2009.

In some embodiments, the exit device 1500 includes a push bar lever 2014 configured to move, e.g., rotate, between a first push bar lever position and a second push bar lever position. The push bar lever 2014 may be moved from the first push bar lever position to the second push bar lever position in response to a push bar of the exit device 1500 being actuated, e.g., pressed by a user. Movement of the push bar lever 2014 from the first push bar lever position to the second push bar lever position may move the slide lever 2004 from the first slide lever position to the second slide lever position. Accordingly, movement of the push bar lever 2014 from the first push bar lever position to the second push bar lever position may move the latch of the exit device 1500 from the extended latch position to the retracted latch position.

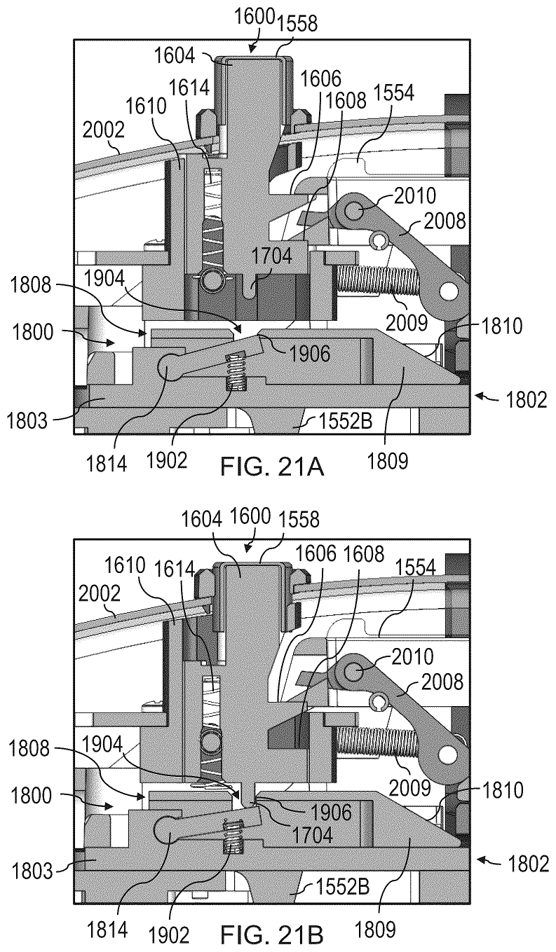

The depicted embodiments of FIGS. 21A and 21B show close-up cross-sectional views of the exit device 1500 illustrating the interaction between the privacy actuator assembly 1600 and the sliding assembly 1800 according to some embodiments. The depicted embodiment of FIG. 21A shows the button 1558 in the first button position and the stop lever 1814 in the coupled position such that movement of the slide 1803 is coupled with movement of the block 1808. In some embodiments, while the button 1558 is in the first button position, the button projection 1704 is free from contact with the stop lever 1814. In the first button position, the first privacy actuator surface 1606 contacts the latch slide 1554, e.g., an upper latch slide surface of the latch slide 1554. In some cases, the button 1558 in the first button position contacts the latch slide 1554 via the first privacy actuator surface 1606, such as in the depicted embodiment of FIG. 21A. In some embodiments, the second privacy actuator surface 1608 contacts the latch slide 1554, e.g., a lower latch slide surface of the latch slide 1554, while the button 1558 is in the first button position. As best seen in the depicted embodiment of FIG. 21A, the stop lever 1814 may contact the coupling surface 1906 while in the coupled position.

The depicted embodiment of FIG. 21B shows button 1558 in the second button position and the stop lever 1814 in the decoupled position such that movement of the slide 1803 is decoupled with movement of the block 1808. As shown in the depicted embodiment of FIG. 21B, the stop lever 1814 may be free of contact with the coupling surface 1906 while in the decoupled position. Also shown in the depicted embodiment of FIG. 21B, the button projection 1704 may extend partially through the block access port 1904 into an interior space of the block 1808 while the button 1558 is in the second button position. In the second button position, the first privacy actuator surface 1606 may contact the latch slide 1554, e.g., on the lower latch slide surface. In some embodiments, the angled surface of the privacy actuator body 1604 is configured to contact and/or move the slide 1554 and/or the guard 2008 as the button 1558 moves from the first button position to the second button position.

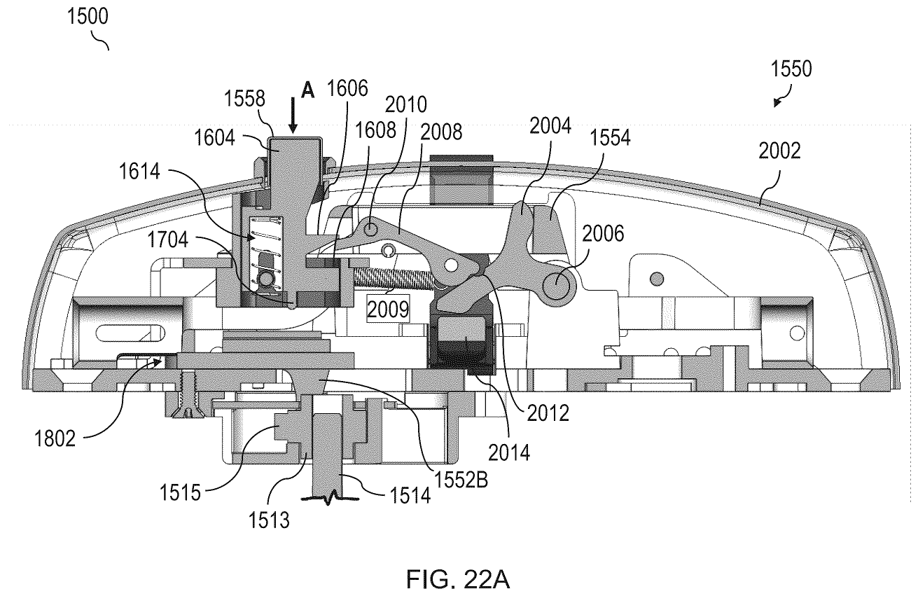

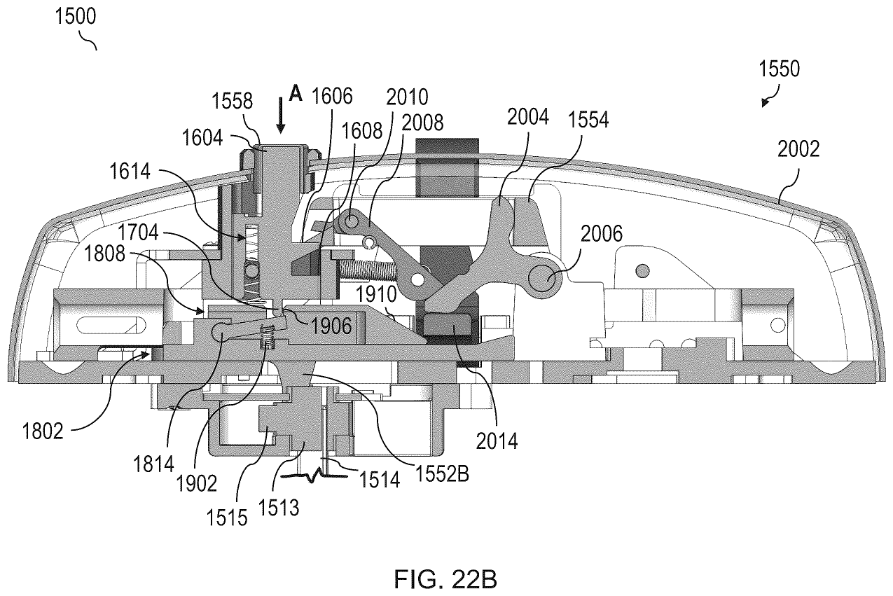

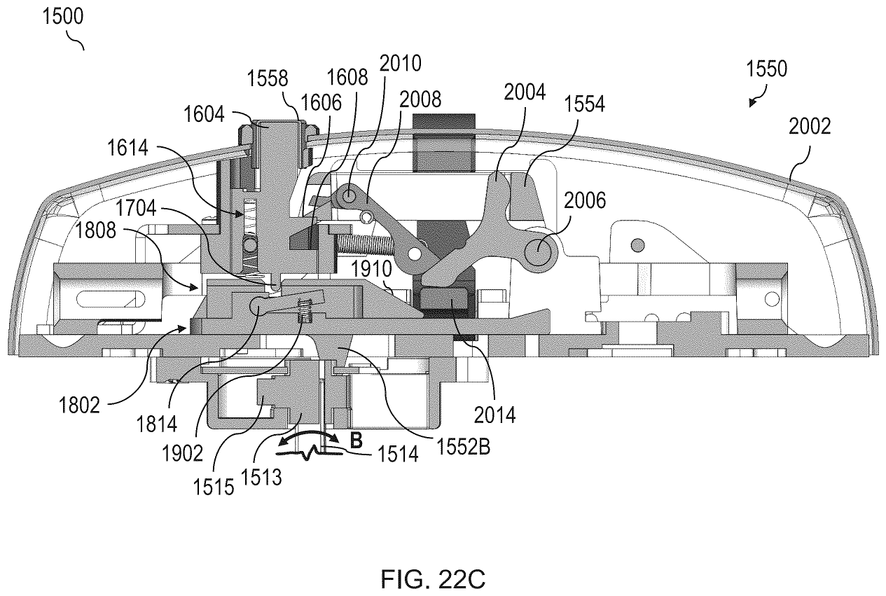

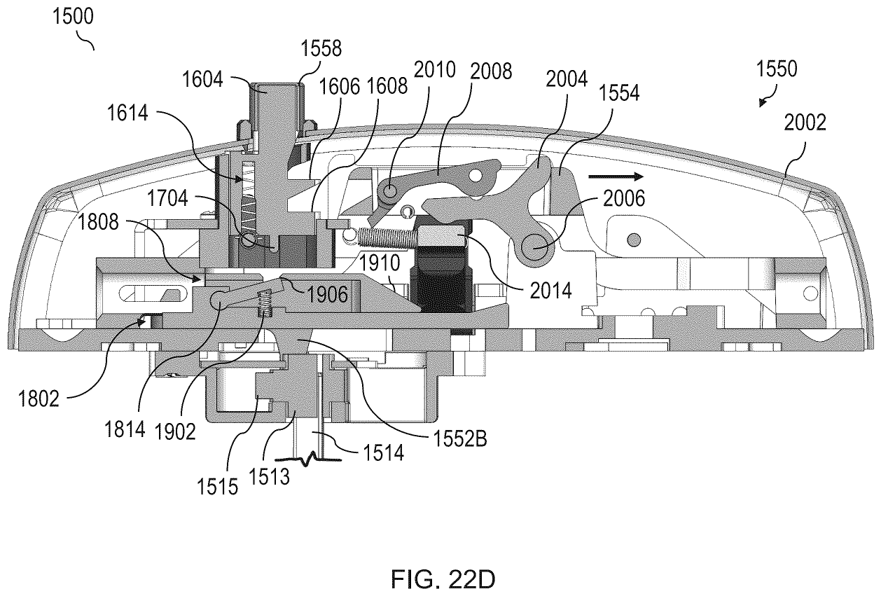

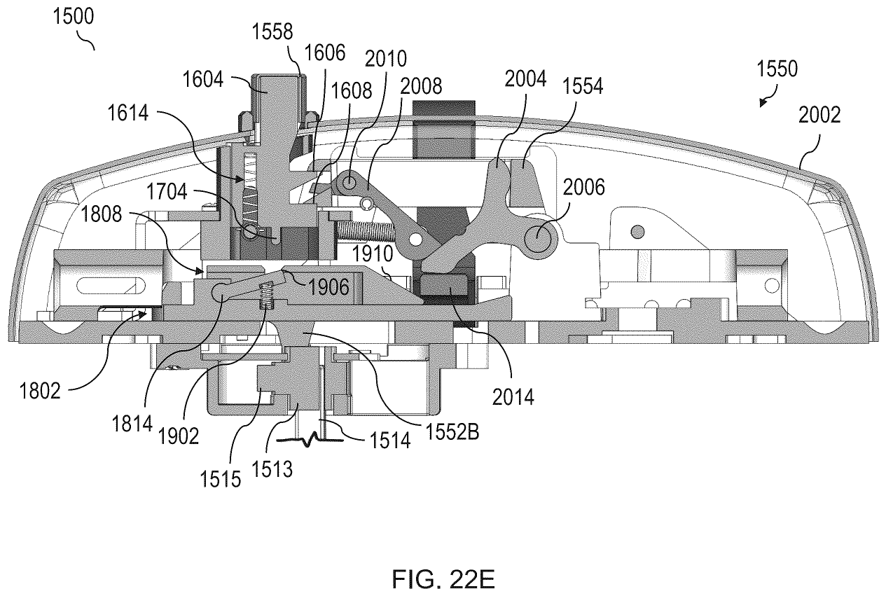

FIG. 22A shows a cross-sectional view of the exit device 1500 with the privacy lock transitioning from a non-privacy configuration to a privacy configuration and the slide 1802 in the first slide position according to some embodiments. In the depicted embodiment of FIG. 22A, the button 1558 is positioned between the first button position and the second button position, which may be the case as button 1558 moves towards the second button position in a direction parallel to the direction of arrow “A”. As illustrated in the depicted embodiment of FIG. 22A, as the button 1558 moves from the first button position to the second button position, the angled surface of the privacy actuator body 1604 may contact the guard 2008 and move the guard 2008 to rotate about a guard pivot 2010 such that the guard disengages with the groove 2012 of the slide lever 2004.

FIG. 22B shows a cross-sectional view of the exit device 1500 of FIG. 22A with the privacy lock in the privacy configuration and the slide 1802 in the first position according to some embodiments. The button 1558 is shown in the second button position in the depicted embodiment of FIG. 22B, with the button projection 1704 contacting the stop lever 1814 while the stop lever 1814 is in the decoupled position. As shown in the depicted embodiment of FIG. 22B, the first privacy actuator body surface 1606 may contact the lower latch slide surface of the latch slide 1554 while the button is in the second button position. The slide 1802 is shown the first slide position, which may be the case while the handle 1512 is in the first handle position, e.g., in a resting position. In some cases, the button 1558 is maintained in the position shown in the depicted embodiment FIG. 22B at least in part due to the weight of the latch slide 1554. For example, the latch slide 1554 may weigh on the button 1558 due to a local direction of gravity, thereby maintaining the button 1558 in the second button position.

FIG. 22C shows a cross-sectional view of the exit device of FIGS. 22A-22B with the privacy lock in the privacy configuration and the slide 1802 in the second position according to some embodiments. The slide 1802 may be configured to slide between the first slide position and the second slide position along an axis extending in a direction parallel to a longitudinal axis of the exit device 1500. The block 1808 may be configured to slide between the first block position and the second block position along the axis extending in a direction parallel to the longitudinal axis of the exit device 1500. As such, the slide 1802 and the block 1808 may be configured to move along parallel axes of movement. As shown in the depicted embodiment of FIG. 22C, the linking shaft 1514 may be positioned in a rotated position about an axis of rotation in a direction following the direction of the arrows “B”, thereby positioning the slide 1802 in the second slide position via contact between the slide projection 1552B and the hub projection 1515. That is, the handle 1512 (not shown) may be in the second handle position, thereby positioning the slide 1802 in the second slide position.

As previously mentioned, a push bar of the exit device 1500 may be pressed to transition the privacy lock from the privacy configuration to the non-privacy configuration. Pressing the push bar may move the push bar lever 2014 from the first push bar lever position to the second push bar lever position. The depicted embodiment of FIG. 22D shows a cross-sectional view of the exit device 1500 of FIGS. 22A-22C with the push bar lever 2014 in the second push bar lever position, the slide lever 2004 in the second slide lever position, the slide 1802 in the first slide position, the block 1808 in the first block position, and the button 1558 in the first button position. The exit device 1500 may be configured as shown in the depicted embodiment of FIG. 22D, for example, while the push bar of the exit device is in an actuated position, e.g., is pushed into a depressed position by a user.

FIG. 22E shows a cross-sectional view of the exit device 1500 of FIGS. 22A-22D with the privacy lock in the non-privacy configuration and the slide 1802 in the first slide position according to some embodiments. The stop lever 1814 is in the coupled position such that movement of the slide 1802, e.g., in response to rotation of the linking shaft 1514, is coupled with movement of the block 1808. As such, in the configuration of the exit device 1500 in the depicted embodiment of FIG. 22E, rotation of the handle 1512 and linking shaft 1514 would move block 1808 from the first block position to the second block position, thereby moving the lift surface 1910 of the block 1808 to move the push bar lever 2014 from the first push bar lever position towards the second push bar lever position, thereby moving the slide lever 2004 from the first slide lever position to the second slide lever position, thereby moving the latch slide 1554 from the first latch slide position to the second latch slide position. In some embodiments, movement of the push bar of the exit device 1500 from the non-actuated position to the actuated position followed by movement of the push bar from the actuated position to the non-actuated position configures the exit device 1500 as shown in the depicted embodiment of FIG. 22E.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

What is claimed is:

1. An exit device comprising:
a latch configured to move between an extended latch position and a retracted latch position; and
a privacy lock configured to transition between a non-privacy configuration and a privacy configuration, wherein in the privacy configuration the privacy lock is configured to maintain the latch in the extended latch position.

2. The exit device of claim 1, wherein the privacy lock includes a privacy actuator configured to transition from a non-privacy configuration and a privacy configuration and a shaft operatively coupled to the privacy actuator and configured to move between a first shaft position and a second shaft position, wherein the shaft is configured to move from the first shaft position to the second shaft position in response to the privacy actuator transitioning from the non-privacy configuration to the privacy configuration, and wherein the shaft is configured to maintain the latch in the extended latch position while in the second shaft position.

3. The exit device of claim 1, further comprising an indicator operatively coupled to the privacy lock, wherein the indicator is configured to provide a privacy indication in response to the privacy lock transitioning to the privacy configuration.

4. The exit device of claim 3, further comprising an indicator switch operatively coupled to the privacy lock and the indicator, wherein the indicator switch is configured to indicate to the indicator that the exit device is in the privacy configuration in response to the privacy lock transitioning to the privacy configuration.

5. The exit device of claim 3, further comprising an indicator lever operatively coupled to the privacy lock and configured to move between an indicator lever non-privacy position and an indicator lever privacy position, wherein the indicator lever is configured to move to the indicator lever privacy position in response to the privacy lock transitioning to the privacy configuration, and further comprising a hub operatively coupling the privacy lock to the indicator lever, wherein the indicator lever is configured to move to the indicator lever privacy position in response to the privacy lock transitioning to the privacy configuration via the hub.

6. (canceled)

7. The exit device of claim 1, further comprising a trim lever operatively coupled to the latch and configured to move between a first trim lever position and a second trim lever position, wherein movement of the trim lever from the first trim lever position to the second trim lever position moves the latch from the extended latch position to the retracted latch position.

8. The exit device of claim 1, further comprising a lever arm operatively coupled to the latch and configured to move between a first lever arm position and a second lever arm position, wherein movement of the lever arm from the first lever arm position to the second lever arm position moves the latch from the extended latch position to the retracted latch position, and further comprising a push bar operatively coupled to the lever arm and moveable between an unactuated push bar position and an actuated push bar position, wherein movement of the push bar from the unactuated push bar position to the actuated push bar position moves the lever arm from the first lever arm position to the second lever arm position.

9. (canceled)

10. The exit device of claim 2, further comprising a catch configured to selectively maintain the position of the shaft in the second shaft position.

11-13. (canceled)

14. The exit device of claim 1, further comprising an override assembly configured to override a state of the exit device to move the latch from the extended latch position to the retracted latch position.

15. (canceled)

16. The exit device of claim 1, wherein the privacy lock includes a push and turn privacy actuator, wherein the push and turn privacy actuator is configured to move between a first linear position and a second linear position, and wherein the push and turn privacy actuator is configured to move between a first rotational position and a second rotational position, and wherein the push and turn privacy actuator is configured to remain in the second linear position in response to movement from the first rotational position to the second rotational position.

17. An exit device comprising:
a latch movable between an extended latch position and a retracted latch position,
a shaft configured to move linearly between a first shaft linear position and a second shaft linear position and rotate between a first shaft rotational position and a second shaft rotational position,
wherein the shaft is configured such that rotation of the shaft from the first shaft rotational position to the second shaft rotational position while the shaft is in the first shaft linear position moves the latch from the extended latch position to the retracted latch position;
a privacy actuator movably coupled to the shaft and configured to move between a non-privacy position and a privacy position, wherein movement of the privacy actuator from the non-privacy position to the privacy position moves the shaft from the first shaft linear position and the second shaft linear position; and
a catch configured to selectively maintain the shaft in the second shaft linear position.

18. The exit device of claim 17, further comprising a push bar operatively coupled to the latch and movable between a resting position and a depressed position, wherein movement of the push bar from the resting position to the depressed position moves the latch from the extended latch position to the retracted latch position, and further comprising a lever arm operatively coupled to the push bar and the latch, wherein the lever arm is movable between a first lever arm position and a second lever arm position, wherein movement of the push bar from the resting position to the depressed position moves the lever arm from the first lever arm position to the second lever arm position, and wherein movement of the lever arm from the first lever arm position to the second lever arm position moves the latch from the extended latch position to the retracted latch position.

19. (canceled)

20. The exit device of claim 17, wherein the catch is configured to selectively maintain the shaft in the second shaft linear position in response to the shaft moving from the first shaft linear position to the second shaft linear position.

21. The exit device of claim 17, further comprising a handle configured to selectively rotate the shaft between the first shaft rotational position and the second shaft rotational position, wherein maintaining the shaft in the second shaft linear position prevents the handle from moving the latch to the retracted latch position.

22. (canceled)

23. The exit device of claim 1, further comprising:
a privacy actuator operatively coupled to the privacy lock and configured to move between a non-privacy position and a privacy position, wherein movement of the privacy actuator from the non-privacy position to the privacy position transitions the privacy lock from the non-privacy configuration to the privacy configuration;
a shaft operatively coupled to the privacy actuator and configured to move between a first shaft position and a second shaft position, wherein the shaft is configured to move from the first shaft position to the second shaft position in response to the privacy actuator moving from the non-privacy position to the privacy position, and wherein the shaft is configured to maintain the latch in the extended latch position while in the second shaft position; and
an indicator configured to provide an indication associated with the exit device.

24. The exit device of claim 23, further comprising an indicator window through which the indication provided by the indicator is visible.

25. (canceled)

26. The exit device of claim 23, wherein the indicator includes an indicator plate operatively coupled to the privacy actuator and an indicator face, wherein the indicator face is coupled to the indicator plate and is configured to provide the indication associated with the exit device.

27. The exit device of claim 26, further comprising an indicator lever operatively coupled to the privacy actuator and configured to move between an indicator lever non-privacy position and an indicator lever privacy position, wherein the indicator lever is configured to move to the indicator lever privacy position in response to the privacy actuator moving to the privacy position, and further comprising a hub operatively coupling the privacy actuator to the indicator lever, wherein the indicator lever is configured to move to the indicator lever privacy position in response to the privacy actuator moving to the privacy position via the hub.

28-29. (canceled)

30. The exit device of claim 27, wherein the indicator lever is configured to rotate between the indicator lever non-privacy position and the indicator lever privacy position, wherein the indicator face is configured to move linearly between a first indicator face position and a second indicator face position, wherein the indicator lever includes an indicator lever projection configured to engage a groove of the hub.

31-32. (canceled)

33. The exit device of claim 27, wherein the indicator is configured to illuminate at least a portion of the hub.

34. The exit device of claim 1, further comprising:
a latch actuator configured to move between an unactuated position and an actuated position;
a coupling configured to move between a coupled position and a decoupled position, wherein in the coupled position the coupling is configured to operatively couple the latch actuator and the latch such that movement of the latch actuator from the unactuated position to the actuated position moves the latch from the extended latch position to the retracted latch position; and
the privacy lock including a button configured to move between a first button position and a second button position, wherein movement of the button from the first button position to the second button position moves the coupling to the decoupled position.

35-43. (canceled)

44. The exit device of claim 34, wherein the button is a push and turn button further configured to rotate between a first rotational position and a second rotational position, and wherein the push and turn button is configured to remain in the second button position in response to rotation from the first rotational position to the second rotational position.

45-46. (canceled)

47. An exit device comprising:
a latch movable between an extended latch position and a retracted latch position;
a block movable between a first block position and a second block position, wherein movement of the block from the first block position to the second block position moves the latch from the extended latch position to the retracted latch position;
a slide movable between a first slide position and a second slide position;
a stop lever movable between a coupled position and a decoupled position, wherein the stop lever is configured to couple movement of the block with the slide while the stop lever is in the coupled position, and wherein, in the decoupled position, the block is decoupled from movement with the slide; and
a privacy lock configured to transition between a non-privacy configuration and a privacy configuration, wherein the privacy lock is configured such that transitioning the privacy lock from the non-privacy configuration to the privacy configuration moves the stop lever to the decoupled position.

48. The exit device of claim 47, wherein the privacy lock comprises a button movable between a first button position and a second button position, wherein movement of the button from the first button position to the second button position transitions the privacy lock to the privacy configuration.

49. The exit device of claim 48, wherein the button comprises a button protrusion, wherein movement of the button to the second button position causes the button protrusion to contact and move the stop lever to the decoupled position, wherein the button protrusion is configured to extend within an interior space of the block while the button is in the second button position.

50-55. (canceled)
